(19) United States
(12) Patent Application Publication
(10) Pub. No.: US 2009/0159133 A1
(43) Pub. Date: Jun. 25, 2009

(54) Electro-Mechanically Controlled Ceramic Based Proportional Valve

(75) Inventors: Robert C. Popke, Hawthorn Woods, IL (US); Robert J. Kral, Dousman, WI (US)

Correspondence Address: MILLER, MATTHIAS & HULL, ONE NORTH FRANKLIN STREET, SUITE 2350, CHICAGO, IL, 60606, US

(73) Assignee: MIDWEST SEALING PRODUCTS, INC., Buffaio Grove, IL (US)

(21) Appl. No.: 11/960,321

(22) Filed: Dec. 19, 2007

(51) Int. Cl. F17D 1/16

(52) U.S. Cl. 137/14; 251/368

(57) ABSTRACT

An electromechanically-controlled ceramic based proportional valve is disclosed. The apparatus may be manufactured with an accompanying ceramic pressure breakdown orifice pack. The apparatus is designed to utilize the wear-resistant properties of ceramic valve components to control the flow of high-pressure fluids using a servo-driven mechanical actuator. The apparatus is designed to control the closing of the poppet valve to prevent slamming of the poppet head into the poppet seat during closing, further preventing wear and tear on the apparatus components. The accompanying pressure breakdown pack is designed to systematically reduce high pressure and high velocity water flow through the device to allow the water to exit at a prescribed lower pressure and flow rate. The breakdown pack also prevents harmful cavitation in the valve assembly by handling the cavitation internally rather than allowing it to propagate itself through the entire valve assembly. The breakdown pack allows for the pre-filling of descaling spray headers in a steel mill descaling system. These headers need to be saturated with water prior to the high-pressure fluid entering the circuit

### FIELD OF THE DISCLOSURE

The present invention generally relates to fluid control valves and, more particularly, relates to fluid control valves adapted to harsh, high-pressure environments such as steel mills.

### BACKGROUND OF THE DISCLOSURE

Steel mills produce steel from iron ore by removing impurities such as sulfur and phosphorous and adding alloying elements such as manganese, nickel, and chromium. The mills then transform the molten steel into slabs and sheets of steel through casting and rolling. After casting and prior to rolling, molten metal begins to cool, and scale formations develop on the surface of the steel. These scales or flaking must be removed prior to rolling. In descaling steel, a high pressure liquid, usually water, is directed toward the surface of the steel via a plurality of jet nozzles. Descale pumps are used to forward large volumes of pressurized water to the nozzles from a reservoir or accumulator. Descale water often contains sand, sediment, and other abrasive materials. Valves are used to turn on and off the flow of water between the pumps and the nozzles based on need.

Conventional poppet valves in this setting are constructed using an elastomeric valve seat or elastomeric gaskets around the poppet head to form a seal when the poppet head and seat are in engagement. Elastomeric materials fail rapidly because the high pressure water containing abrasive materials cuts and erodes the elastomeric material of the valves as it flows from the descale pump to the nozzles. In addition, conventional poppet valves in this setting are designed to close off this high pressure water source within one or two seconds. Conventional poppet valve systems do not control the speed at which the poppet valve opens and closes, causing the poppet head to slam into the seat. As a result of this slamming, the energy contained in the high pressure water causes system shock which propagates upstream from the valves and damages valves, pumps, piping, and related system components.

In view of the above, it is apparent that there is a need for a valve and a method of controlling said valve that is less susceptible to high pressure water containing abrasive contaminants and which produces less system shock upon opening and closing off the high pressure water source.

### SUMMARY OF THE DISCLOSURE

Accordingly, the present disclosure provides a poppet valve apparatus and method which is directed at reducing cost and wear on the descaling system.

In accordance with one aspect of the disclosure, a low viscosity, high pressure fluid control valve assembly for use in high pressure applications is disclosed which comprises a valve housing, a poppet mounted within the valve housing, a valve seat mounted in the valve body, and a servo motor. The valve housing defines a valve body, a flow inlet, and a flow outlet. The poppet within the valve housing has balancing channels to channel pressurized fluid through the poppet to allow the poppet to become pressure balanced with a hydraulic bias to be closed. The poppet is adapted to move between an open position allowing fluid communication between the inlet and outlet. The poppet further includes a valve head made of ceramic. The valve head engages the valve seat when the poppet is in the closed position. The valve seat is made of ceramic. The servo motor is operatively connected to the poppet to move the poppet between the open and closed positions.

In accordance with another aspect of the disclosure, a low viscosity, high pressure fluid control valve assembly for use in steel mill applications is disclosed which comprises a valve housing, a poppet mounted within the valve housing, a valve seat mounted in the valve body, and a servo motor. The valve housing defines a valve body, a flow inlet, and a flow outlet. The poppet within the valve housing has balancing channels to channel pressurized fluid through the poppet to allow the poppet to become pressure balanced with a hydraulic bias to be closed. The poppet is adapted to move between an open position allowing fluid communication between the inlet and outlet. The poppet further includes a valve head made of ceramic. The valve head engages the valve seat when the poppet is in the closed position. The valve seat is made of ceramic. The servo motor is operatively connected to the poppet to move the poppet between the open and closed positions.

In accordance with another aspect of the disclosure, a method for controlling a flow of high pressure fluid is disclosed which comprises providing a valve assembly consisting of a ceramic poppet valve and a ceramic valve seat, a ceramic pressure breakdown orifice pack and a header holding a plurality of spray nozzles; determining differential pressure between a flow inlet and a flow outlet; determining a fluid pressure within the poppet valve; sending signals representative of the differential pressure, fluid pressure and position to a microprocessor which controls a servo motor; calculating a servo motor position using the microprocessor's algorithm to determine the next position of the servo motor; and pre-filling of the header in order to saturate said header with water prior to the high pressure water source being opened in the circuit.

In accordance with a still further aspect of the disclosure, a low viscosity, high pressure fluid control valve assembly for use in steel mill applications is disclosed which comprises a valve housing, a poppet mounted within the valve housing, a valve seat mounted in the valve body, a servo motor, and a ceramic pressure breakdown orifice pack. The valve housing defines a valve body, a flow inlet, and a flow outlet. The poppet within the valve housing has balancing channels to channel pressurized fluid through the poppet to allow the poppet to become pressure balanced with a hydraulic bias to be closed. The poppet is adapted to move between an open position allowing fluid communication between the inlet and outlet. The poppet further includes a valve head made of ceramic. The valve head engages the valve seat when the poppet is in the closed position. The valve seat is made of ceramic. The servo motor is operatively connected to the poppet to move the poppet between the open and closed positions. The ceramic pressure breakdown orifice pack contains a series of chambers with varying diameter holes acting as orifices and ceramic plates on each side of the orifice.

These and other aspects and features of the disclosure become more apparent upon reading the following detailed description taken in conjunction with the accompanying drawings.

### BRIEF DESCRIPTION OF THE DRAWINGS

FIG. 1 is a schematic view of a representative steel mill descaling system.

FIG. 2 is a side view of a descaling valve assembly constructed in accordance with the teachings of the disclosure.

FIG. 3 is a top view of the valve assembly in FIG. 2.

FIG. 4 is an end view of the valve assembly in FIG. 2.

FIG. 5 is an end view of the valve assembly in FIG. 2 from the end opposite that of FIG. 4.

FIG. 6 is an enlarged partial sectional view of the valve of FIG. 2.

FIG. 7 is an enlarged section view of a pre-fill housing constructed in accordance with the teachings of the disclosure.

FIG. 8 is an end view of the pre-fill housing of FIG. 7.

While the present disclosure is susceptible to various modifications and alternative constructions, certain illustrative embodiments thereof have been shown in the drawings and will be described below in detail. It should be understood, however, that there is no intention to limit the present invention to the specific forms disclosed, but on the contrary, the intention is to covet all modifications, alternative constructions, and equivalents falling within the spirit and scope of the present invention.

### DETAILED DESCRIPTION OF THE DISCLOSURE

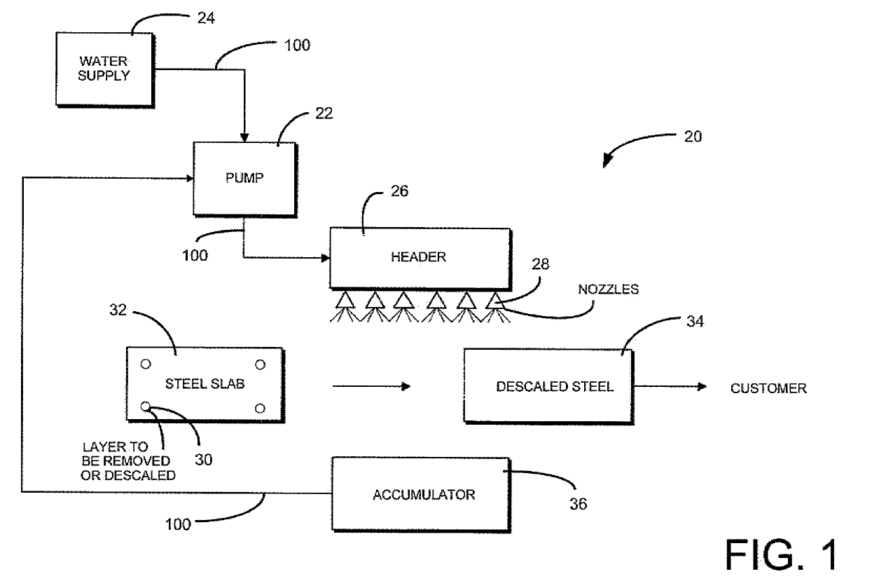

FIG. 1 is a schematic view of a representative steel mill 20 that could advantageously employ the teachings of this disclosure. While the mill 20 is shown as having slab steel to be descaled, it is to be understood that the teachings of this disclosure could be used in myriad other environments were high pressure fluid is to be controlled.

Referring again to FIG. 1, the steel descaling system includes a water supply 24, a fluid conduit system 100 connecting the water supply 24 to the inlet of the descale pump 22, and a fluid conduit system 100 connecting the outlet of the descale pump 22 to a header 22 holding a plurality of nozzles 28. High pressure fluid is then sprayed though the nozzles 28 onto a steel slab 32 which has a layer 30 to be descaled resulting in a descaled steel slab 34. Excess fluid is amassed in the accumulator 36 and thereby relayed via the fluid conduit system 100 back to the pump 22 inlet.

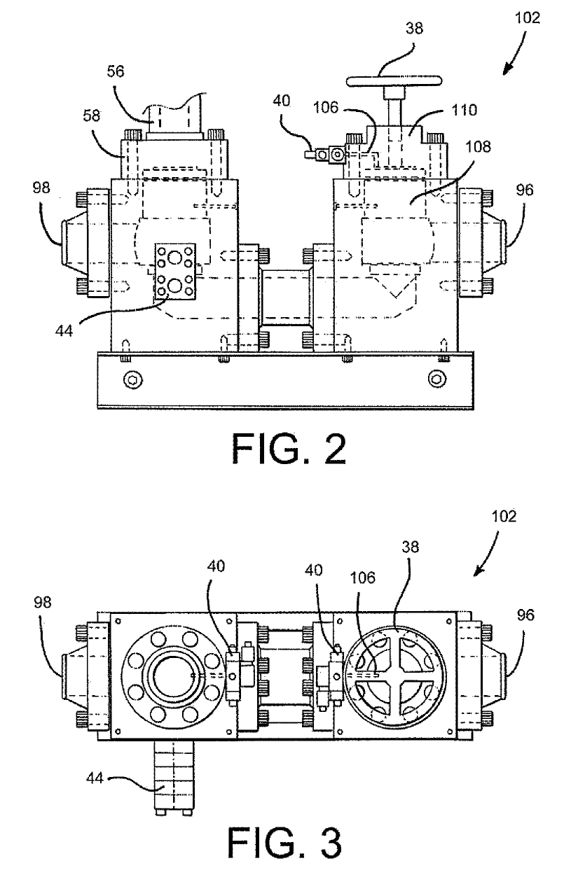

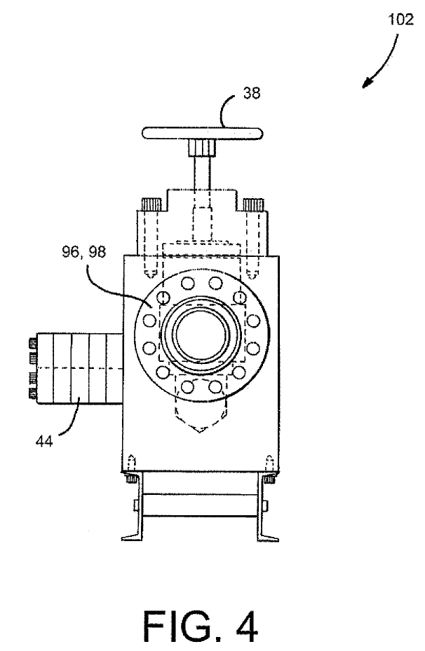

As shown in FIGS. 2-4, the valve assembly 102 includes a manual stop 38, a flow inlet 96 and outlet 98, a pilot line 106, a main valve 108, a main valve housing 110 and an operating pilot 40. Each of those elements will be described in further detail herein. Fluid flow is directed at flow inlet 96 and moves through the system to flow outlet 98. A manual stop 38 is provided for emergency situations when the flow of high-pressure water needs to be turned off immediately. Within the main valve housing 110, there are provided a main valve 108 operated with a pilot pressure supplied as an external signal from a manual pilot valve 40 or from a manual stop 38. Upon receiving a signal from the pilot valve 40 or pressure from the manual stop 38, the main valve 108 will close and shut off the flow of high-pressure fluid to the rest of the system 102.

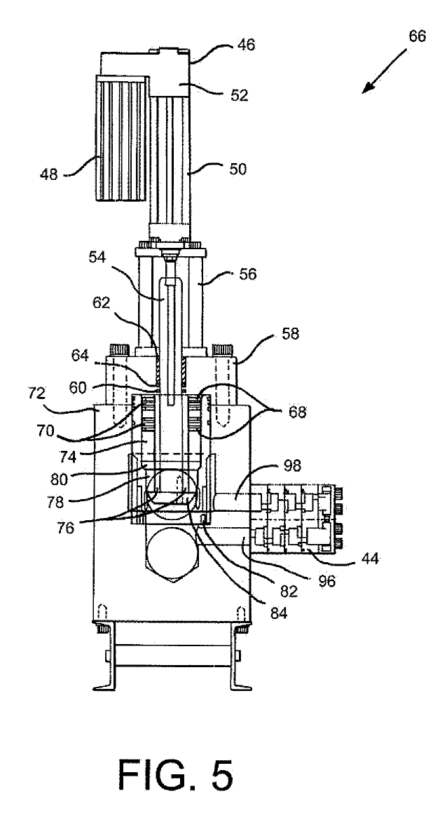

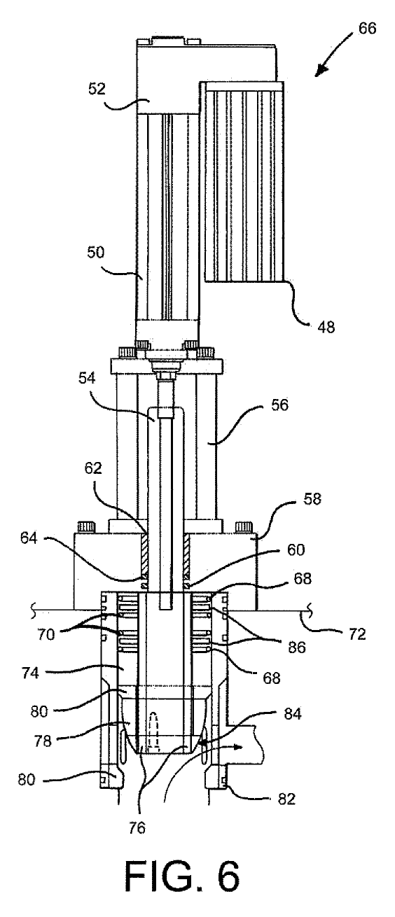

FIG. 5 shows the descale valve assembly 102 from the end at which the poppet valve assembly 66 is situated and FIG. 6 shows the actual poppet valve assembly 66 in isolation and in greater detail. From such views, it can be seen that the linear actuator 46, servo motor 48, electromechanical actuator 50, gear box 52, balancing rod 54, stand-off 56, cap 58, wiper 60, bearings 62, seals 64, valve housing 72, poppet 74, balancing passage 76, ceramic flow restrictor 78, ceramic seat 80, pressure ring 82, stainless steel flow restrictor 84, exclusion ring 86, flow inlet 96, pressure reducer 44 and flow outlet 98. These elements are described in further detail herein.

Assuming the main valve 108 is not closed, high pressure fluid is received by the poppet valve assembly 66 via the flow inlet 96 and flows through the pressure reducer 44. The reduced-pressure fluid then flows out through the flow outlet 98 to the header 26. The operation of the poppet valve assembly 66 allows the poppet 74 to be opened and closed at variable rates and speeds by use of the servo motor 48 controlled electromechanical actuator.

In one embodiment, the servo motor 48 controlled electromechanical actuator proportionally closes the poppet 74 during the last stages of its closing (for example 0 5 to 1 0 seconds) to prevent slamming of the poppet 74 against the ceramic seat 80. The servo motor 48 may receive pressure and position readings via sensors (not shown) and uses these readings internally in its microprocessor (not shown) to calculate the speed at which the poppet 74 is closed against the ceramic seat 80. The servo motor 48 controls the lineal actuator 46 and gear box 52 to actuate the electromechanical actuator 50 which then moves the poppet 74 to the calculated position. In another embodiment, the servo motor may just be programmed to move at the same speed and distance with every cycle, if such values are pre-determined.

A balancing rod 54 is coupled to the electromechanical actuator 50 on one end and the poppet 74 on the other end. A seal 64 is in place at the interface between the balancing rod 54 and poppet 74. A stand 56 is provided to protect moving parts such as the balancing rod 54 and electromechanical actuator 50. A cap 58 and housing 72 are provided to seal the poppet 74 system. Beatings 68 and seals 70 are provided between the poppet 74 and the housing 72.

The poppet 74 and seat 80 are constructed of ceramic or other hardened material to utilize the wear resistance properties of these materials. By using such elements the short life span of elastomeric grommets and seals is overcome. An additional design feature of the valve 66 allows for the pressurized fluid to continually be channeled through the poppet 74 through balancing passages 76. This allows the poppet 74 to become pressure-balanced with a hydraulic bias to be closed, allowing the poppet 74 to be moved by the electromechanical actuator 50 with lower force.

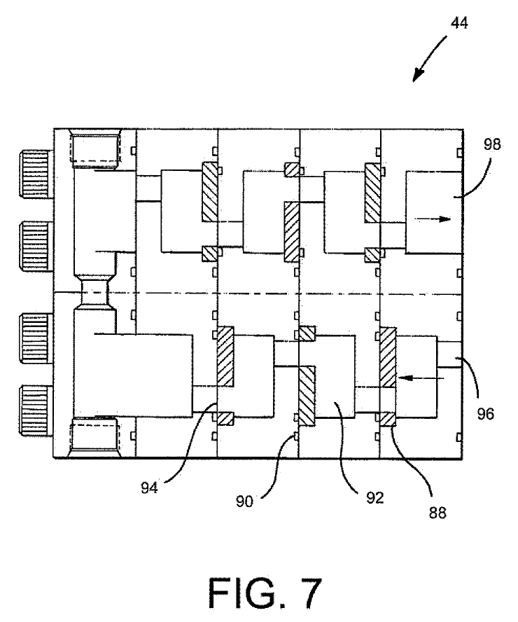

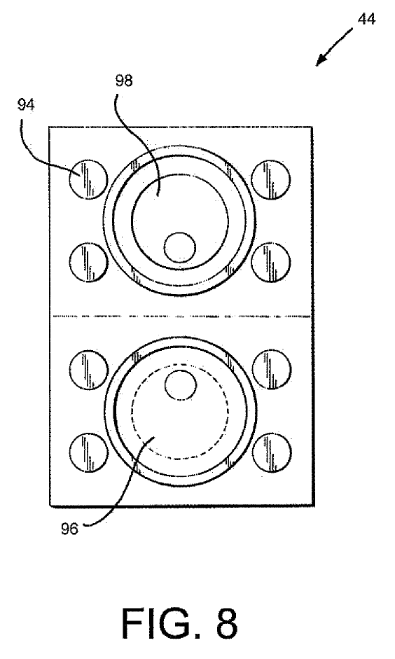

Referring to FIGS. 7 and 8, the pressure reducer 44 is defined. This product utilizes the wear resistant properties of the ceramic components to reduce high-pressure water flow throughout the descale valve assembly 102. The high-pressure water enters the pressure reducer through the flow inlet 96. From there, the water enters a series of chambers with varying-diameter orifices 94 that create pressure drops as the water passes through. As these pressure drops occur, the flow rates are decreased and cavitation occurs. This cavitation causes erosion with most materials. However, the components of the pressure reducer 44 are made of ceramic and therefore less susceptible to damage from cavitation. As this reduced-pressure water enters the various chambers 92 of the pressure reducer, this process repeats itself until such time that the potential loss of energy is dissipated to a less violent state. The pressure reducer 44 is used for pre-filling of the spray headers 26 that are fed by the high-pressure water. These headers 26 need to be saturated with water prior to the high pressure source being opened in the circuit.

From the foregoing, it can be seen that the teachings of the disclosure can be used to manufacture an electromechanically-controlled ceramic-based proportional valve and accompanying ceramic pressure breakdown orifice pack. The invention is manufactured to withstand wear and tear in extreme high-pressure conditions such as seen in a steel mill. Because of its ability to withstand extreme conditions, the invention results in lower maintenance costs and therefore lower operating costs for its users, as well as a longer product life.

What is claimed is:

1. A low viscosity, high pressure fluid control valve assembly for use in high-pressure applications, comprising:
a valve housing defining a valve body, a flow inlet and a flow outlet;
a poppet mounted within the valve housing, the poppet including balancing channels to channel pressurized fluid through the poppet to allow the poppet to become pressure balance with a hydraulic bias to be closed, said poppet adapted to move between an open position allowing fluid communication between the inlet and outlet and a closed position disallowing fluid communication between the inlet and outlet, the poppet including a valve head made of ceramic;
a valve seat mounted in the valve body, the valve head engaging the valve seat when the poppet is in the closed position, the valve seat being made of ceramic; and
a servo motor operatively connected to the poppet to move the poppet between the open and closed positions.

2. The valve assembly of claim 1, wherein the servo motor is controlled by a microcontroller.

3. The valve assembly of claim 1, further comprising a gear box.

4. The valve assembly of claim 1, further comprising an electro-mechanical actuator.

5. The valve assembly of claim 1, further comprising a differential pressure sensor sensing differential pressure across the flow inlet and outlet and an electrical connection from such pressure sensor to said servo motor for feedback control.

6. The valve assembly of claim 1, further comprising a pressure sensor sensing pressure within said poppet and an electrical connection from such pressure sensor to said servo motor for feedback control.

7. The valve assembly of claim 1, further comprising a position sensor which is coupled to sense a displacement of the poppet valve head in relation to the poppet valve seat and an electrical connection from the position sensor to the servo motor for feedback control.

8. The valve assembly of claim 1, wherein the poppet valve head and poppet seat are composed of a non-ceramic hardened material.

9. The valve assembly of claim 1, wherein the valve assembly is attached to a header with a plurality of descaling nozzles for selectively directing liquid under pressure toward a steel slab.

10. A low-viscosity, high pressure fluid control valve assembly for use in steel mill applications, comprising:
a valve housing defining a valve body, a flow inlet and a flow outlet;
a poppet mounted within the valve housing, the poppet including balancing channels to channel pressurized fluid through the poppet to allow the poppet to become pressure balanced with a hydraulic bias to be closed, said poppet adapted to move between an open position allowing fluid communication between the inlet and outlet and a closed position disallowing fluid communication between the inlet and outlet, the poppet including a valve head made of ceramic;
a valve seat mounted in the valve body, the valve head engaging the valve seat when the poppet is in the closed position, the valve seat being made of ceramic; and
a servo motor operatively connected to the poppet to move the poppet between the open and closed positions.

11. The valve assembly of claim 10, wherein the servo motor is controlled by a microcontroller.

12. The valve assembly of claim 10, further comprising a gear box.

13. The valve assembly of claim 10, further comprising an electromechanical actuator.

14. The valve assembly of claim 10, further comprising a differential pressure sensor sensing differential pressure across the flow inlet and outlet and an electrical connection from such pressure sensor to said servo motor for feedback control.

15. The valve assembly of claim 10, further comprising a pressure sensor sensing pressure within said poppet and an electrical connection from such pressure sensor to said servo motor for feedback control.

16. The valve assembly of claim 10, further comprising a position sensor which is coupled to sense a displacement of the poppet valve head in relation to the poppet seat and an electrical connection from such position sensor to said servo motor for feedback control.

17. The valve assembly of claim 10, wherein the valve assembly is attached to a header with a plurality of descaling nozzles for selectively directing liquid under pressure toward a steel slab.

18. A method for controlling a flow of high pressure fluid, comprising:
providing a valve assembly consisting of a ceramic poppet valve and a ceramic valve seat, a ceramic pressure breakdown orifice pack, and a header holding a plurality of splay nozzles;
determining differential pressure between a flow inlet and a flow outlet;
determining a fluid pressure within the poppet valve;
sending signals representative of the differential pressure, fluid pressure and position to a microprocessor which controls a servo motor;
calculating a servo motor position using the microprocessor's algorithm to determine the next position of the servo motor; and
prefilling of the header in order to saturate said header with water prior to the high pressure water source being opened in the circuit.

19. The method of claim 18, further comprising using the new angular position of the servo motor to turn gears coupled to the servo motor by a certain angle as calculate within the microcontroller.

20. The method of claim 18, further comprising exerting force on an electro-mechanical actuator to change the position of the poppet valve in relation to the valve seat.

21. The method of claim 18, further comprising the step of proportionally closing the poppet value during its last stages for the last such that the poppet valve does not slam into the valve seat.

22. The method of claim 18, further comprising maintaining the relative positions of the poppet valve in relation to the poppet seat until the signal inputs to the servo motor change.

23. A low-viscosity, high pressure fluid control valve assembly for use in steel mill applications, comprising:
a valve housing defining a valve body, a flow inlet and a flow outlet;
a poppet mounted within the valve housing, the poppet including balancing channels to channel pressurized fluid through the poppet to allow the poppet to become pressure balanced with a hydraulic bias to be closed, said poppet adapted to move between an open position allowing fluid communication between the inlet and outlet and a closed position disallowing fluid communication between the inlet and outlet, the poppet including a valve head made of ceramic;
a valve seat mounted in the valve body, the valve head engaging the valve seat when the poppet is in the closed position, the valve seat being made of ceramic;
a servo motor operatively connected to the poppet to move the poppet between the open and closed positions; and
a ceramic pressure breakdown orifice pack containing a series of chambers with varying diameter holes acting as orifices, and ceramic plates on each side of the orifices.

24. The valve assembly of claim 23, wherein the servo motor is controlled by a microcontroller.

25. The valve assembly of claim 23, further comprising a gear box.

26. The valve assembly of claim 23, further comprising an electro-mechanical actuator.

27. The valve assembly of claim 23, further comprising a differential pressure sensor sensing differential pressure across the flow inlet and outlet and an electrical connection from such pressure sensor to said servo motor for feedback control.

28. The valve assembly of claim 23, further comprising a pressure sensor sensing pressure within said poppet and an electrical connection from such pressure sensor to said servo motor for feedback control.

29. The valve assembly of claim 23, further comprising a position sensor which is coupled to sense a displacement of the poppet valve head in relation to the poppet seat and an electrical connection from such position sensor to said servo motor for feedback control.
